(19) United States
(12) Patent Application Publication
(10) Pub. No.: US 2014/0246622 A1
(43) Pub. Date: Sep. 4, 2014

(54) HEAT REACTIVATED ADSORBENT GAS FRACTIONATOR AND PROCESS

(71) Applicant: JOHN THELEN, Ocala, FL (US)

(72) Inventor: JOHN THELEN, Ocala, FL (US)

(21) Appl. No.: 13/782,339

(22) Filed: Mar. 1, 2013

(51) Int. Cl. B01J 20/34

(52) U.S. Cl. CPC B01J 20/3483
USPC 252/194; 96/144

(57) ABSTRACT

A system for regenerating a desiccant bed having water adsorbed thereon to a desired moisture content comprising: a desiccant bed used to produce dry product gas having a first end and a second end; a source of feed gas, heated by a gas compression process fluidly connected to the desiccant bed wherein feed gas flows through the desiccant bed such that the heat present in the feed gas desorbs a portion of the moisture from the regenerating desiccant bed; and a source of cooling gas fluidly connected to the desiccant bed wherein the cooling gas flows through the desiccant bed in a closed loop such that moisture is desorbed from the bed as the desiccant bed cools and is carried back to the first end of the desiccant bed to provide additional cooling wherein moisture in the cooling gas is adsorbed.

### TECHNICAL FIELD

The present disclosure relates generally to methods and systems for drying a gas using desiccant beds and more particularly to a method and system for regenerating a desiccant bed to a desired moisture content using heat of compression.

### BACKGROUND OF THE INVENTION

The presence of moisture in gas leads to many problems in different manufacturing operations. For example, the presence of water in a pneumatic system can be very detrimental, the water becomes the agent for a contamination chain. Rust and scale rapidly degrades the efficiency of the system by clogging the orifices and jets of pneumatic equipment; rust collects in bends and pockets creating excessive pressure drops; pipe connectors are weakened and leaks are encouraged; rust can break loose, pass down stream and render pneumatic instruments inoperative.

Adsorption type desiccant dryer systems are most commonly used to produce extremely dry air, which can be used for pneumatic equipment in manufacturing plants. These dryers typically have a pair of towers each containing a bed of desiccant material, for example, silica gel, alumina, or zeolitic molecular sieves. In heat of compression drying systems, the towers alternately dry the gas stream and then are regenerated.

When drying the gas stream the desiccant will eventually become moisture laden and additional moisture cannot be removed from the gas during the adsorption cycle until the desiccant has been regenerated. In general, the more thorough the regeneration, the better the quality of the effluent air, in terms of having a low dew point, and the more moisture which can be adsorbed before the next regeneration. It is generally understood that the quality of regeneration is dependent upon the temperature and dryness of the regenerating media. See Arnold L. Weiner, “Drying of Liquids and Gases,” page 6, Chemical Engineers, Sep. 16, 1974. It is known that desiccant may be regenerated by a variety of techniques, including heating the desiccant or; passing a dry purge gas through the desiccant. Such techniques may be referred to as heat-regenerated and pressure swing systems. Included among heat-regenerated systems are heat-of-compression dryers with the latter designation deriving from a known practice of using the heat generated by compressing the gas to be dried.

One basis for comparison of the various regeneration techniques is the amount of energy required for regeneration. Very generally, pressure swing regeneration typically employs the most energy (through use of compressed, product air as the regeneration medium).

Heat regenerated dryers are often preferred because they typically employ somewhat less regeneration energy and thus do not cost as much to operate. Of all adsorption type gas dryers, heat of compression dryers have the lowest operating costs, however, depending upon the temperature and moisture content of the compressor discharge gas, the product gas dew point may not be as low as what the application demands. The dew point of dry air is critical to certain applications such as instrument air because it can ultimately lead to equipment failure. Therefore, improving the dew point performance of the heat-of-compression regenerated dryer without expending too much energy and increasing operation costs is desired.

Another problem with heat of compression dryers is the presence of temperature and dew point spikes which occur commonly in heat of compression dryers as a result of the high desiccant temperature at the onset of the adsorption phase. In typical heat of compression dryers, at the time the newly regenerated desiccant bed is first switched over to the adsorption phase, the desiccant is still relatively hot from the regeneration using the gas heated by the compression process. The hot desiccant is not able to hold as much moisture as a cooler desiccant, so there is a “spike” of moist gas that passes out of the tower until the desiccant is cooled. It would be desirable to minimize these temperature and dew point spikes such that the drying operation of one tower is not interrupted while the desiccant is cooled without significantly increasing the energy costs of the dryer.

Known drying systems using heat of compression, however, do not provide an improvement in dew point performance and desiccant regeneration while minimizing dew point spikes without significantly increasing the energy costs of the drying system.

### SUMMARY OF THE INVENTION

A system for regenerating a desiccant bed having water adsorbed thereon to a desired moisture content is provided. The system includes a desiccant bed which has a first end and second end and is used to produce dry product gas. The system further includes a source of feed gas that is heated by a compression process that is fluidly connected to the desiccant bed wherein the feed gas flows through the desiccant bed such that the heat present in the hot feed gas desorbs a portion of the moisture from the regenerating desiccant bed. The system further includes a source of cooling gas fluidly connected to the desiccant bed wherein the cooling gas flows through the desiccant bed in a closed loop such that moisture is desorbed from the bed as the desiccant bed cools and is carried back to the first end of the desiccant bed to provide additional cooling wherein moisture in the cooling gas is adsorbed.

A method of regenerating a bed of desiccant having water adsorbed thereon to a desired moisture content is also provided. The method includes (a) desorbing a portion of the moisture from the regenerating desiccant bed by passing a feed gas heated by a gas compression process through the desiccant bed and (b) cooling the desiccant bed by passing a cooling gas, traveling in a closed loop, through the desiccant bed wherein the cooling gas progressively cools the desiccant bed from the first end to the second end as it travels through the desiccant bed and as the desiccant bed cools, moisture is desorbed from the bed, and carried back to the first end of the desiccant bed to provide additional cooling wherein moisture in the cooling gas is adsorbed.

### BRIEF DESCRIPTION OF THE DRAWINGS

FIG. 1 is a schematic illustration of a heat of compression drying gas system in accordance with the present disclosure using the captive cooling phase.

FIGS. 2-4 are schematic illustrations of the dew point capability of the heat of compression gas drying system in accordance with the present disclosure using heat of compression phase and the captive cooling phase.

FIGS. 5-7 are schematic illustrations of the dew point capability of the heat of compression drying gas system in accordance with the present disclosure using a first heat of compression heating phase, a second heating phase and the captive cooling phase.

### DETAILED DESCRIPTION

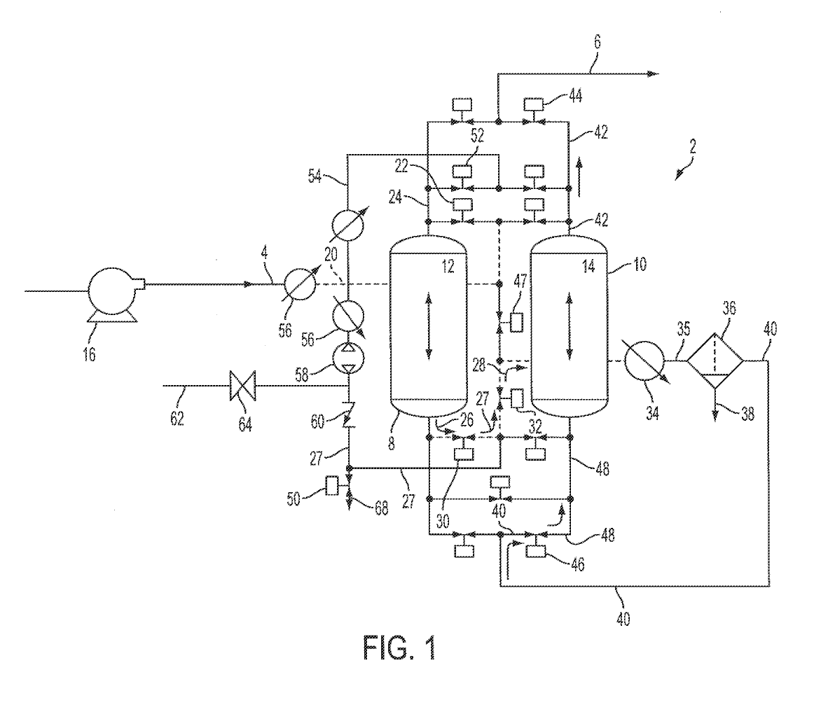

Referring now to FIG. 1, a schematic illustration of a heat of compression gas dryer 2 in accordance with the present disclosure is shown. The heat of compression dryer 2 has a dryer inlet 4 and a dryer outlet 6. The dryer inlet 4 receives hot feed gas having moisture content. The dryer outlet 6 delivers dry product gas, which then can be used, for example, as a source of dry air for the pneumatic instruments in a plant. The dry product gas from the dryer outlet 6 may also be used for any other purpose that requires dry gas. The gas used in the dryer 2 may be air or any other gas having a moisture content that needs to be dried.

The heat of compression gas dryer 2 includes a first tower 8 and a second tower 10. The first tower 8 and the second tower 10 each contain a desiccant bed 12, 14 such that the hot feed gas from the dryer inlet 4 can flow through the desiccant beds 12, 14 in the tower and become significantly drier.

When the dryer 2 is in operation, one of the towers (either the first tower 8 or the second tower 10) is used to dry the gas stream while the desiccant bed 12, 14 in the other tower (either the first tower 8 or the second tower 10) is being regenerated. For example, the first desiccant bed 12 in the first tower 8 can be regenerated, while the feed gas is being dried in the second tower 10. In other words, the first tower 8 is inactive (with respect to drying) and is in a regeneration phase and the second tower 10 is active and in an adsorption drying phase.

Regeneration of the desiccant bed 12, 14 may occur in two or three different phases. For example, in some embodiments, regeneration of the desiccant bed 12, 14 is accomplished by a heat of compression phase followed by a captive cooling phase. In other embodiments, the desiccant bed 12, 14 is regenerated by a first heat of compression phase, followed by a second heating phase and a captive cooling phase. A second heating phase is used to further strip moisture from the desiccant bed 12, 14 after the first regeneration phase. The captive cooling phase in this instance is performed after the second heating phase to complete regeneration of the desiccant bed 12, 14. The second heating phase, however, is not always required to adequately regenerate the desiccant bed 12, 14. In some instances, regeneration of the desiccant bed 12, 14 and the desired dew point may be achieved by using the heat of compression phase and captive cooling phase without the second heating phase. Regeneration of the desiccant bed 12, 14 including each of the phases—heat of compression phase, second heating phase and captive cooling phases explained further in detail below.

A compressor 16 may provide the source of the hot feed gas, which may be for example, compressed air. The source of hot feed gas is delivered to the dryer inlet 4 for the dryer 2. In some embodiments of the disclosure, a booster heater 18 may be used to heat the gas from the compressor before the gas enters the first tower 8. A booster heater 18 is shown in FIG. 1. The booster heater 18 is connected downstream from the compressor discharge or dryer inlet 4 and upstream of the first desiccant bed 12 of the first tower 8. The booster heater 18 is used to heat the feed gas to a temperature that is necessary to regenerate the desiccant bed 12, 14 to the desired moisture content.

Increasing the temperature of the feed gas flowing through the dryer inlet 4 may be useful depending on the condition (i.e., temperature and humidity) of the feed gas entering the dryer 2 from the compressor 16. For example, if the discharge from the compressor 16 has a high humidity level, the desiccant bed 12, 14 often cannot be regenerated to a level which will produce a sufficiently low dew point when drying. Using the booster heater 18 to raise the temperature of the compressor 16 discharge to a level may result in the regeneration characteristic of providing the dew point desired, e.g., −40° F. Using a booster heater 18, however, is not required.

In FIG. 1, the feed gas in the dryer inlet 2 is heated by the booster heater 18 and exits the booster heater 18 through conduit 20. The feed gas in conduit 20 is then directed through valve 22 and enters conduit 24 to the first tower 8. The hot feed gas passes through the first tower 8, which is in the heat of compression phase, where the hot feed gas heats and desorbs moisture from the first desiccant bed 12, which requires regeneration.

The feed gas then exits the first tower 8 through conduits 26, 27, and 28 and flows through open valves 30 and 32 where the feed gas enters an aftercooler 34. The feed gas is cooled in the aftercooler 34 where the water vapor is condensed and flows through conduit 35. Following the aftercooler 34 is a separator 36, which separates the condensed water vapor from the feed gas and collects the condensed water. The condensed water is discharged from the separator 36 through outlet 38. The gas exits the separator 36 through conduit 40 and then passes through the second tower 10, which is in the adsorption or drying phase.

Inside the second tower 10, water is further removed from the feed gas to provide for dry product gas delivery at the dryer outlet 6. The second desiccant bed 14 in the second tower 10 adsorbs water from the feed gas passing through the second tower 10. The dry product gas exits the second tower 10 at conduit 42 and passes through valve 44 where it reaches the dryer outlet 6. The dry product gas at the dryer outlet 6 can then be used for any of the applications previously mentioned that require dry gas.

During the heat of compression phase and adsorption phase shown in FIG. 1, the following valves shown in FIG. 1 are open: 22, 30, 32, 44 and 46. All other valves shown in FIG. 1 are closed and no gas flows through any of the closed valves while the first tower 8 is in the heat of compression phase and the second tower 10 is in an adsorption phase.

Once it has been determined that the first tower 8 has been sufficiently heated to regenerate the first desiccant bed 12 in the first tower 8, the heat of compression phase of the first desiccant bed 12 in the first tower 8 is complete. In some embodiments, after the heat of compression phase is complete in the first tower 8, the second heating phase starts in the first tower 8 followed by the captive cooling phase. The second heating phase, however, is not required after heat of compression phase to regenerate the first desiccant bed 12. Regeneration of the first desiccant bed 12 in the first tower 8 may be accomplished by the heat of compression phase followed by the captive cooling phase.

Assuming that the heat of compression phase is complete, the first tower 8 is ready to begin the captive cooling phase. While the captive cooling phase occurs in the first tower 8, the second tower 10 continues to operate in the adsorption phase producing dry gas. At this time, the appropriate valves are opened and dosed to end the heat of compression phase in the first tower 8 and begin the captive cooling phase as explained below. The operation of the first tower 8 in the captive cooling phase and the second tower 10 in the adsorption phase is shown in FIG. 1.

In the captive cooling and adsorption phase, the source of hot feed gas from the compressor 16 discharge continues to enter the dryer system 2 at dryer inlet 4. Hot feed gas then flows through conduit 20, open valve 47 and conduits 28, 35 and 40. The hot feed gas passes through the aftercooler 34 and the separator 36, where the hot feed gas is cooled, moisture is condensed, separated and drained from the system. The hot feed gas in conduit 40 passes through valve 46 to conduit 48 where the hot feed gas enters the second tower 10. Inside the second tower 10, the hot feed gas passes through the second desiccant bed 14 where the desiccant desorbs moisture from the hot feed gas. The dry product gas then exits the second tower 10 at outlet 42, where it passes through open valve 44 and the dry product gas exits the dryer 2 at dryer outlet 6.

While the second tower 10 continues to produce dry product gas as described above, the captive cooling phase occurs in the first tower 8. The primary purpose of the captive cooling phase is to adequately cool the desiccant bed 12 in the first tower 8 while simultaneously desorbing additional moisture from the desiccant bed 12 and to carry that desorbed moisture with the cooling gas flow back to the inlet end of the desiccant bed 12 (for drying) where it is re-adsorbed. Cooling continues for either a fixed time period or until a predetermined temperature that will allow the desiccant bed 12 in the first tower 8 to return to the adsorption cycle. In some embodiments, the predetermined temperature ranges from 60 to 180 degrees Fahrenheit (as measured in the cooling gas exiting the desiccant bed). Furthermore, it is important to cool the desiccant bed 12 in the first tower 8 because lowering the temperature of the desiccant bed 12 before the first tower 8 starts the adsorption cycle is necessary to minimize any dew point spikes in the dry product gas. In some embodiments, the degree of cooling provided is such that the desiccant bed 12, 14 can return to the adsorption phase with no more than, for example, a 10° F. change in the dew point of the dry product gas leaving the dryer outlet 26.

At the end of the heat of compression phase in the first tower 8, the first tower 8 is depressurized to atmosphere and the captive cooling phase starts. The first tower 8 remains depressurized during the captive cooling phase.

The desiccant bed 12 is cooled to a predetermined time or temperature using a cooling gas. The dryer 2 and the first tower 8 are arranged such that the source of cooling gas is fluidly connected to the desiccant bed 12, 14 where cooling gas can flow through the desiccant bed 12, 14 until the desiccant bed 12, 14 is cooled to the predetermined time or temperature. In one embodiment, the cooling gas that flows through the first tower 8 in the captive cooling phase may be ambient air that is present due to the depressurization of the first tower 8.

When the first tower 8 is depressurized, the following valves are opened: 30, 44, 46, 47, 50 and 52. All other valves shown in FIG. 1 are closed. In this instance, the cooling gas, which is present in conduit 54 from depressurizing the first tower 8, flows into a purge cooler 56 using the blower 30 shown in FIG. 1. The purge cooler 56 maintains the temperature of the cooling gas equal to or below the predetermined temperature. The cooling gas then enters the blower 58 where the cooling gas is blown through a check valve 60, into conduit 27 and into valve 30 where the cooling gas enters the first tower 8 and cools the first desiccant bed 12. The cooling gas exits the first tower 8 at conduit 24 and flows through valve 52, where the gas returns to conduit 54. This captive cooling phase continues until the temperature of the first desiccant bed 12 is lowered to the predetermined temperature or the predetermined cooling time has expired.

Once the cooling phase of the first desiccant bed 12 is complete, the first tower 8 can switch from operating in the regeneration phases (i.e., heat of compression phase, second heating phase—when used and, the captive cooling phase) to the adsorption phase. Now in the adsorption phase, the first tower 8 (instead of the second tower 10) can begin to dry the feed gas by using the newly regenerated first desiccant bed 12 to adsorb moisture from the feed gas to produce dry product gas.

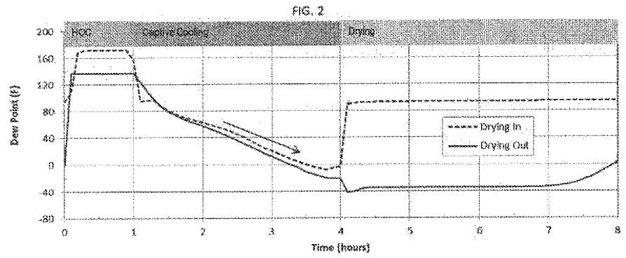

The captive cooling phase provides an improvement in the dew point of the dry product gas beyond what can be achieved by a dryer 2 that only uses the first heat of compression phase. The dew point performance of a dryer 2 which uses a heat of compression phase and a captive cooling phase is graphically illustrated in FIGS. 2-4.

The curves shown on the graphs in FIGS. 2-4 represent different positions within the desiccant bed 12. For example, the performance of the feed gas at the inlet and the outlet to the desiccant bed 12 in the first tower 8 are each represented by different curves on the graphs. In FIGS. 2-4, the x-axis depicts time in hours. The time represents the dryer 2 during the heat of compression phase, the captive cooling phase and the adsorption phase. For example, from 0 to 1 hour, one of the towers 8, 10 is in the heat of compression phase; from 1 hour to 4 hours, the tower 8, 10 is in the captive cooling phase and from four hours to eight hours, the tower 8, 10 is in the adsorption phase.

In FIG. 2, the x-axis depicts time in hours and the y-axis depicts dew point in degrees Fahrenheit. As can be seen from the graph in FIG. 2, the dew point of the cooling gas at the “Drying In” position, where cooling gas enters the desiccant bed 12, falls from hour 1 to hour 4 as the cooling gas is dried by previously cooled desiccant. This relatively dry cooling gas is further dried as it contacts previously cooled desiccant. The combination of dried cooling gas and the elevated temperature deeper within the desiccant bed 12, creates conditions that are favorable for additional desorption. The moisture content of the heated cooling gas approaches equilibrium with desiccant toward the exit end of the bed thus the falling dew point of the hot cooling gas at the “Drying Out” position in FIG. 2 reflects the concurrent fall in the desiccant moisture content toward the dryer outlet.

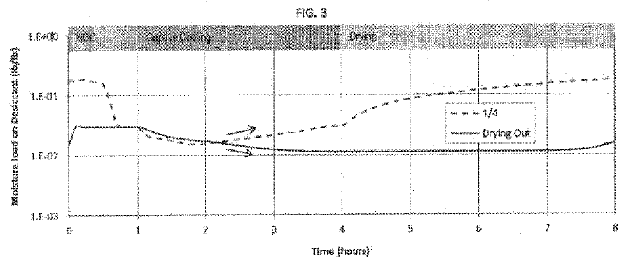

In FIG. 3, a graph is shown in which the same x-axis is used as in FIG. 2, which the x-axis depicts time in hours and the y-axis depicts the loading in which is the mass of water per pound of desiccant at each step of the heating, cooling and adsorption phases. The graph in FIG. 3 illustrates that that during cooling, the desiccant moisture content at the “Drying Out” position falls as the combination of hot desiccant and dry cooling gas desorbs residual moisture from desiccant bed. The moisture desorbed exits the desiccant bed 12, passes through the purge gas cooler and is re-adsorbed at the cooled inlet portion of the desiccant bed 12 as indicated by the rising moisture level shown in FIG. 3 as the ¼ Bed Length. During the captive cooling period, moisture content thus increases toward the inlet end of the desiccant bed 12 and decreases through the remainder of the desiccant bed 12.

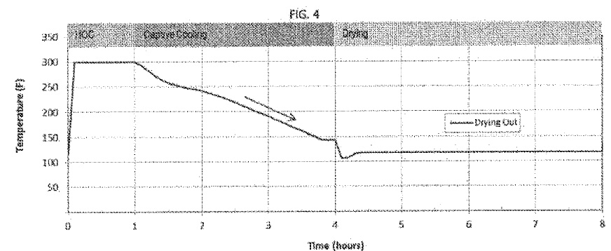

In FIG. 4, a graph is shown in which the x-axis depicts time in hours and the y-axis depicts the temperature of the desiccant bed 12 in the first tower 8. As shown in FIG. 4, in this example, the temperature at the “drying out” position of the desiccant bed 12 is cooled from 300° F. at the end of the heat of compression phase to less than 143 degrees Fahrenheit at the end of the captive cooling phase.

The captive cooling phase uses no dry product gas to strip additional moisture from the desiccant bed 12, 14 therefore, the full gas flow from the compressor is available for the end user and none of the energy required to compress that gas is used for regeneration of the dryer. As a result, this heat of compression dryer design is more efficient than prior art heat of compression dryers 2.

During the captive cooling phase, cooling gas circulates from the blower 58 and into the heated desiccant bed 12, 14. Heat transfers from the first hot desiccant that the cooling gas contacts upon entering the desiccant bed 12, 14, which reduces the temperature of the desiccant and increases the temperature of the cooling gas. The cooling gas, now heated, passes from the desiccant bed 12, 14 to the purge cooler 56 where it is cooled. The cooling gas circulates through the blower 58 and back to the desiccant bed 12, 14 to provide additional cooling. Because the inlet portion of the desiccant bed 12, 14 was previously cooled, it now has the capacity to adsorb moisture from the cooling gas. Therefore, the cooling gas is dehydrated as it passes through the cooled desiccant. The dehydrated cooling gas passes deeper into the desiccant bed 12, 14 coming into contact with hotter desiccant. In this portion of the desiccant bed 12, 14, heat and moisture transfer from the desiccant and into the cooling gas thereby further reducing moisture levels deep within the desiccant bed 12, 14. The now hot and “wet” cooling gas passes out of the desiccant bed 12, 14, to the purge cooler 56, through the blower 58 and back to the desiccant bed 12, 14 where moisture from the cooling gas is once again adsorbed.

As this process continues, the desiccant bed 12, 14 cools and moisture desorbs from deep within the desiccant bed 12, 14 and is re-adsorbed at the inlet to the desiccant bed 12, 14. The captive cooling phase thus recovers heat from the desiccant during tower cooling and that heat, in combination with the “pre-dried” cooling gas, causes additional moisture to desorb from the desiccant, leaving the bulk of the desiccant with a lower residual moisture level at the end of the captive cooling phase. As a result of the captive cooling phase, when the desiccant bed 12, 14 is placed back on-line to dry the process stream, it is not only cool but the moisture content has been redistributed within the desiccant bed 12, 14 such that moisture is more concentrated at the inlet to the desiccant bed 12, 14 and less concentrated at the outlet to the desiccant bed 12, 14. Because the desiccant toward the outlet to the desiccant bed 12, 14 holds less moisture, the desiccant bed 12, 14 is capable of drying the process stream to a lower dew point than would be achieved without the captive cooling phase.

In some embodiments, a second heating phase is performed after the heat of compression phase and prior to the captive cooling phase. The second heating phase uses a source of purge gas that is fluidly connected to the desiccant bed 12, 14 such that purge gas flows through the desiccant bed 12, 14 until the moisture content of the desiccant bed 12, 14 is reduced to the desired moisture content. Examples of suitable purge gas include air, ambient air, dry product gas or some other external gas source.

In FIG. 1, ambient air is used as the purge gas and the purge gas enters through conduit 62 and open valve 64 where the purge gas is blown by the blower 58 up to conduit 54. The purge gas passes through cooler 56, then through heater 66. The heater 66 raises the temperature of the purge gas which will further strip the first desiccant bed 12 of moisture. After being heated, the purge gas flows through valve 52 and into conduit 24 where the purge gas enters the first tower 8. The purge gas exits the first tower 8 at conduit 26 and flows through valve 30. The purge gas then flows from valve 30 into conduit 27 and exits the dryer 2 at open depressurization valve 50 and outlet 68.

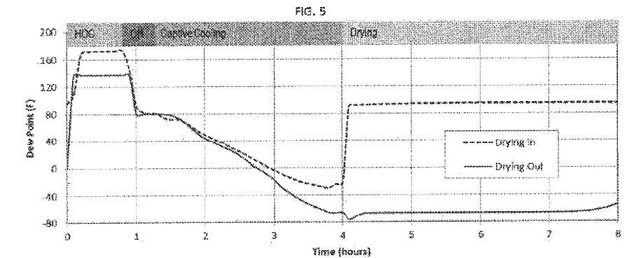

The dew point performance of a dryer 2, which uses both a heat of compression phase and second heating phase followed by the captive cooling phase is graphically illustrated in FIGS. 5-7.

The two curves shown on the graphs in FIGS. 5-7 represent different positions within the desiccant bed 12. For example, the performance of the feed gas at the inlet and the outlet to the desiccant bed 12 in the first tower 8 are represented by different curves on the graphs. In FIGS. 5-7, the x-axis depicts time in hours. The time represents the dryer 2 during the heat of compression phase, the second heating phase, the captive cooling phase and the adsorption phase. For example, from 0 to 1.3 hours, one of the towers 8, 10 is in the heat of compression phase and the second heating phase; from 1.3 hours to 4 hours, the tower 8, 10 is in the captive cooling phase and from four hours to eight hours, the tower 8, 10 is in the adsorption phase.

In FIG. 5, the x-axis depicts time in hours and the y-axis depicts dew point in degrees Fahrenheit. As can be seen from the graph in FIG. 5, in this example, the 2^{nd} heat phase is performed at 300° F., equal to the heat of compression temperature, however, because the 2^{nd} heat period uses purge gas with a lower dew point after the captive cooling phase is complete, during the adsorption phase, the desiccant bed 12 is able to achieve well below a −40 Fahrenheit dew pant temperature.

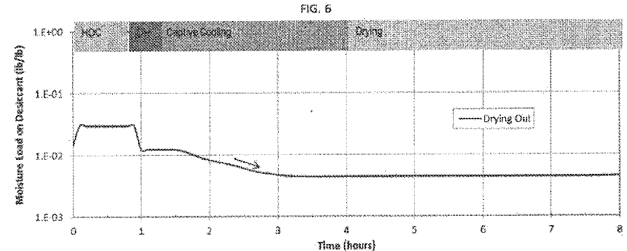

In FIG. 6, a graph is shown in which the x-axis depicts time in hours and the y-axis depicts the loading in lb/lb, which is the mass of water per pound of desiccant at each step of the heat of compression, 2^{nd} heating, captive cooling and adsorption phases. The graph in FIG. 6 illustrates that, as a result of the 2^{nd} heating phase, the moisture content at the end of regeneration has been reduced below that shown in FIG. 3 which makes possible the improved dew point illustrated in FIG. 5.

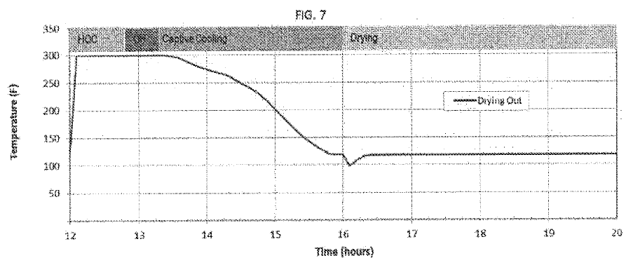

In FIG. 7, a graph is shown in which the x-axis depicts time in hours and the y-axis depicts the temperature of the desiccant bed 12 in the first tower 8. As shown in FIG. 4, the temperature at the outlet to the first desiccant bed 12 experiences little to no change in temperature at the onset of the adsorption cycle.

What is claimed is:

1. A system for regenerating a desiccant bed having water adsorbed thereon to a desired moisture content comprising:
a desiccant bed used to produce dry product gas having a first end and a second end;
a source of feed gas, heated by a gas compression process fluidly connected to the desiccant bed wherein feed gas flows through the desiccant bed such that the heat present in the feed gas desorbs a portion of the moisture from the regenerating desiccant bed; and
a source of cooling gas fluidly connected to the desiccant bed wherein the cooling gas flows through the desiccant bed in a closed loop such that moisture is desorbed from the bed as the desiccant bed cools and is carried back to the first end of the desiccant bed to provide additional cooling wherein moisture in the cooling gas is adsorbed.

2. The system of claim 1 wherein the desiccant bed regeneration is improved such that when the desiccant bed returns to an adsorption cycle the dew point is lower and the desiccant bed is cooled such that there is no more than a 10 degrees Fahrenheit change in the dew point of the dry product gas.

3. The system of claim 1 wherein the source of feed gas is from the discharge of a compressor.

4. The system of claim 1 further comprising a booster heater connected downstream of the source of feed gas and upstream of the desiccant bed such that feed gas flows through the booster heater and is heated to a temperature necessary to regenerate the desiccant to the desired moisture content.

5. The system claim 1 wherein the cooling gas is air.

6. The system of claim 1 further comprising a cooler fluidly connected to the source of cooling gas upstream of the desiccant bed.

7. The system of claim 1 further comprising a blower fluidly connected to the source of cooling gas wherein the blower is used to continuously blow cooling gas through the desiccant bed.

8. The system of claim 1 further comprising a source of purge gas fluidly connected to the desiccant bed such that purge gas flows through the desiccant bed until the moisture content of the desiccant bed is reduced to the desired moisture content.

9. A method of regenerating a bed of desiccant having water adsorbed thereon to a desired moisture content comprising the steps of:
(a) desorbing a portion of the moisture from the regenerating desiccant bed by passing a feed gas, heated by a gas compression process, through the desiccant bed; and
(b) cooling the desiccant bed by passing a cooling gas, traveling in a closed loop, through the desiccant bed wherein the cooling gas progressively cools the desiccant bed from the first end to the second end as it travels through the desiccant bed and as the desiccant bed cools, moisture is desorbed from the bed, and carried back to the first end of the desiccant bed to provide additional cooling wherein moisture in the cooling gas is adsorbed.

10. The method of claim 9 wherein the desiccant bed regeneration is improved such that when the desiccant bed is returned to an adsorption cycle, the dew point is lower and the desiccant bed is cooled such that there is no more than a 10 degrees Fahrenheit change in the dew point of the dry product gas.

11. The method of claim 9 wherein the source of feed gas is from the discharge of a compressor.

12. The method of claim 9 further comprising the step of heating, prior to the desorbing step, wherein the hot feed gas is heated using a booster heater that is connected downstream of the compressor and upstream of the desiccant bed such that the hot feed gas flows through the booster heater and is heated to a temperature that is necessary to regenerate the desiccant bed to the desired moisture content.

13. The method of claim 9 wherein the cooling gas is air.

14. The method of claim 9 wherein a cooler is fluidly connected o the source of cooling gas upstream of the desiccant bed.

15. The method of claim 9 wherein a blower is fluidly connected to the source of cooling gas wherein the blower is used to continuously blow cooling gas through the desiccant bed.

16. The method of claim 9 further comprising the step of passing a portion of purge gas through the desiccant bed, after the desorbing step and prior to the cooling step, until the moisture content of the desiccant bed is reduced to the desired moisture content.

17. A means for regenerating a desiccant bed having water adsorbed thereon to a desired moisture content comprising:
a desiccant bed;
a source of hot feed gas fluidly connected to the desiccant bed wherein hot feed gas flows through the desiccant bed such that the heat present in the hot feed gas desorbs a portion of the moisture from the regenerating desiccant bed; and
a source of cooling gas fluidly connected to the desiccant bed wherein the cooling gas flows through the desiccant bed in a closed loop such that moisture is desorbed from the bed as the desiccant bed cools and is carried back to the first end of the desiccant bed to provide additional cooling wherein moisture in the cooling gas is adsorbed; and
wherein desiccant bed regeneration is improved such that when the desiccant bed returns to an adsorption cycle the dew point is lower and the desiccant bed is cooled such that there is no more than a 10 degrees Fahrenheit change in the dew point of the dry product gas.
